(19) United States
(12) Patent Application Publication
(10) Pub. No.: US 2011/0117518 A1
(43) Pub. Date: May 19, 2011

(54) APPLICATOR TIP

(76) Inventor: GARY J. POND, Milwaukee, WI (US)

(21) Appl. No.: 12/949,363

(22) Filed: Nov. 18, 2010

Related U.S. Application Data
(60) Provisional application No. 61/281,454, filed on Nov. 18, 2009.

(51) Int. Cl. A61C 5/04

(52) U.S. Cl. 433/89

(57) ABSTRACT

Methods and devices for delivering precise metered amounts of dental material during a dental procedure. The invention provides devices and methods for restricting the delivery area of the exit of a dental compule or capsule, thereby providing a specific amount of dental material. The devices include applicator tips having a smaller fluid exit than that of the compule or capsule that can be mated externally with a dental compule or capsule to reduce the amount of instant dental material being delivered from the capsule or compule.

### RELATED APPLICATION

This application claims the benefit of U.S. Provisional Patent Application Ser. No. 61/281,454, filed 18 Nov. 2009.

### BACKGROUND OF THE INVENTION

The present invention relates to devices and methods for use in medical procedures, and, more particularly for use in dental procedures. More particularly, the present invention relates to devices, methods, and procedures for restoring and repairing teeth and tooth decay.

Techniques for repairing and shaping teeth with decay and/or defects have improved over time. Generally speaking, repairs are made by surgically removing decayed or unwanted tooth structure, followed by filling in the removed area with a dental composite filling to properly shape or reshape the area. In certain procedures, such as root canal procedures, the dentist or dental technician is operating in a very small space, which requires accuracy and precision in properly addressing and repairing the root canal. Recently, improvements in dental practices have allowed more precise filling and repairing of teeth.

For example, in the last several years microscope enhanced dentistry (MED), or microdentistry, has developed. MED utilizes a microscope and the use of very small tools to carry out dental procedures and surgical operations, such as in the preparation of a root canal. The small areas of the individual canals require the use of small tools, with the use of microscope further enhancing the procedures. MED allows more precise and accurate attention when performing such procedures.

As stated above, restorative dental compositions and materials are used in dental procedures and are well known in the art. Generally, such materials comprise a relatively viscous paste or resin material. These compositions are usually delivered by way of a syringe or dental gun that is capable of delivering a predetermined amount of material for a particular procedure. The devices may contain a preloaded amount of dental material within the device, or the devices may have a compule or capsule of material inserted into the device. The device will then be used to deliver the material to the dental area being worked upon. However, because of the viscosity and the composition of the dental materials, prior art delivery devices have not been capable of providing small, precise amounts of dental materials. While the devices are capable of delivering dental compositions to an area, the delivered material is often more than is required for a particular procedure. The delivery systems do not provide metered amounts of material that are commensurate with the small areas that materials are to be delivered.

As stated, restorative dental materials may be stored in a capsule or compule that is used in connection with a delivery syringe or gun. These materials are generally a paste, being a relatively viscous type of material. The stored dental material will be pushed by a plunger or similar device out of the compule and exit a nozzle. Because of the viscosity of the dental material, the nozzles that are used for delivering the material have a diameter and area that is larger than desired. While the nozzles are designed with a smaller outlet then the general size of the compule or capsule, the devices are not capable of metering the small amounts of material required. Devices have been contemplated to reduce the diameter of the capsule or compule diameter. For example, Clark, U.S. Pub. No. 2009/0191506, contemplates the insertion of an additional tip into the exiting nozzle. While the diameter of the device is reduced, the pressure and force delivered by the exiting dental material inhibit the ability of the additional tip to be held in place while delivering the dental material from commonly used capsules and compules. Consequently, such devices and similar devices cannot effectively and consistently be used for precisely delivering the dental material.

Accordingly, it is desired to provide devices and methods that will allow the controlled delivery of small amounts of restorative dental materials.

### SUMMARY OF THE INVENTION

The present invention provides devices and methods for delivering precise, metered amounts of dental compositions, such as restorative dental compositions, for use in dental procedures. The invention will provides methods and devices for delivering small amounts of dental materials that can be used in connection with currently existing delivery devices, dental materials, and compules and capsules that contain the dental materials.

The tips of the present invention are also for applying flowable composite, a non-viscous dental adhesive, into fissures and cavities into teeth, in areas not previously accessible by prior art devices.

The present invention further provides an applicator tip that is capable of being attached to the exterior of a compule or capsule that is used for delivering a dental material. The compule or capsule has an exit nozzle for delivering the dental material. The applicator tip allows for a reduction in the diameter and/or the cross-sectional area of the nozzle, thereby allowing for a more precise, metered amount of dental material to be delivered for a dental procedure.

The present invention provides an arrangement that can be attached to currently existing devices to provide metered amounts of dental materials. The applicator tip will be applied externally to the exit nozzle of the capsule, compule, or other device that contains the dental material. The applicator tip comprises barbs, rings, threads, or other similar gripping means that will allow the applicator tip to be securely fastened to the nozzle structure, without the applicator tip becoming dislodged from the nozzle during the delivery process. The present invention can be used together with current dental delivery devices, capsules, and compules, without modification needed for the current devices and containers.

### BRIEF DESCRIPTION OF THE DRAWINGS

FIG. 1 is a side plan view of a composite material delivery device, with a compule containing dental material being shown for insertion into the delivery device.

FIG. 2 is a side plan view of the device of FIG. 1 after the compule has been inserted into the delivery device, demonstrating the delivery of dental material.

FIG. 3 is a close-up cross-sectional view of a material capsule delivering dental material.

FIG. 4 is a perspective view of an applicator tip according to the present invention.

FIG. 5 is a cross-sectional view of an applicator tip taken along line 5-5 of FIG. 4.

FIG. 6 is a cross-sectional view of an alternate arrangement for an applicator tip taken along line 6-6 of FIG. 4.

FIG. 7 is a partial exploded view of an applicator tip of FIG. 4 being joined to the compule of FIG. 1.

FIG. 8 is a partial cutaway view of the tip as shown in FIG. 7, with the applicator tip delivering dental material.

FIG. 9 is a perspective view of another tip designed according to the present invention.

FIG. 10 is a cross-sectional view of a further arrangement for an applicator tip, demonstrating alternate means for attaching the applicator tip to a delivery device.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

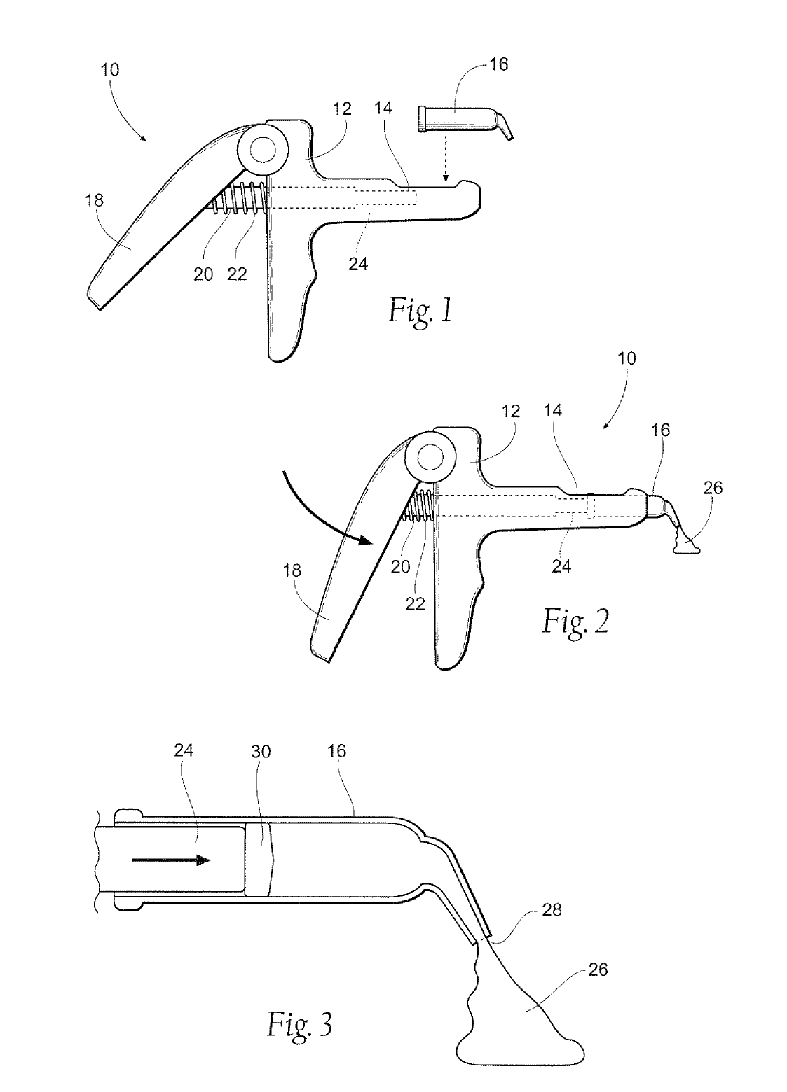

FIG. 1 is a side plan view of a delivery device 10 used in connection with the present invention. The device 10 generally comprises a main body 12 that has an opening 14 for receiving a compule 16. The main body 12 is pivotally connected to a handle 18. The handle is connected to a piston 20 that is biased against the body 12 by way of a spring 22. The handle 18 can be moved inwardly and outwardly to push the piston towards a plunger 24.

As shown in FIG. 2, the compule 16 is placed within the opening 14. The handle 18 is moved inwardly to compress the piston 20, with the piston 20 pushing the plunger 24 inwardly to interact with the compule 16 to release dental material 26 from the device 10. It should be understood that the device 10 shown in FIGS. 1 and 2 is merely exemplary of devices that can be used to deliver dental materials as discussed. Other devices may include syringes or other hand-held devices, with such devices being operated in a variety of fashions to deliver dental material.

FIG. 3 shows a close-up cross-sectional view of the plunger 24 interacting with the compule 16 to release the dental material 26. The forward movement applied by the handle 18 in FIG. 2 causes the plunger 24 to move inwardly, thereby moving the dental material 26 forward and out of an exit or nozzle end 28 located on the compule 16. The plunger 24 preferably pushes up against a plug 30 or other surface so that the plunger 24 does not have to directly interact with the dental material 26. As stated with the device 10, other arrangements, capsules, and computes can be used to deliver the dental material 26, such as disposable devices that have preloaded amounts of dental material.

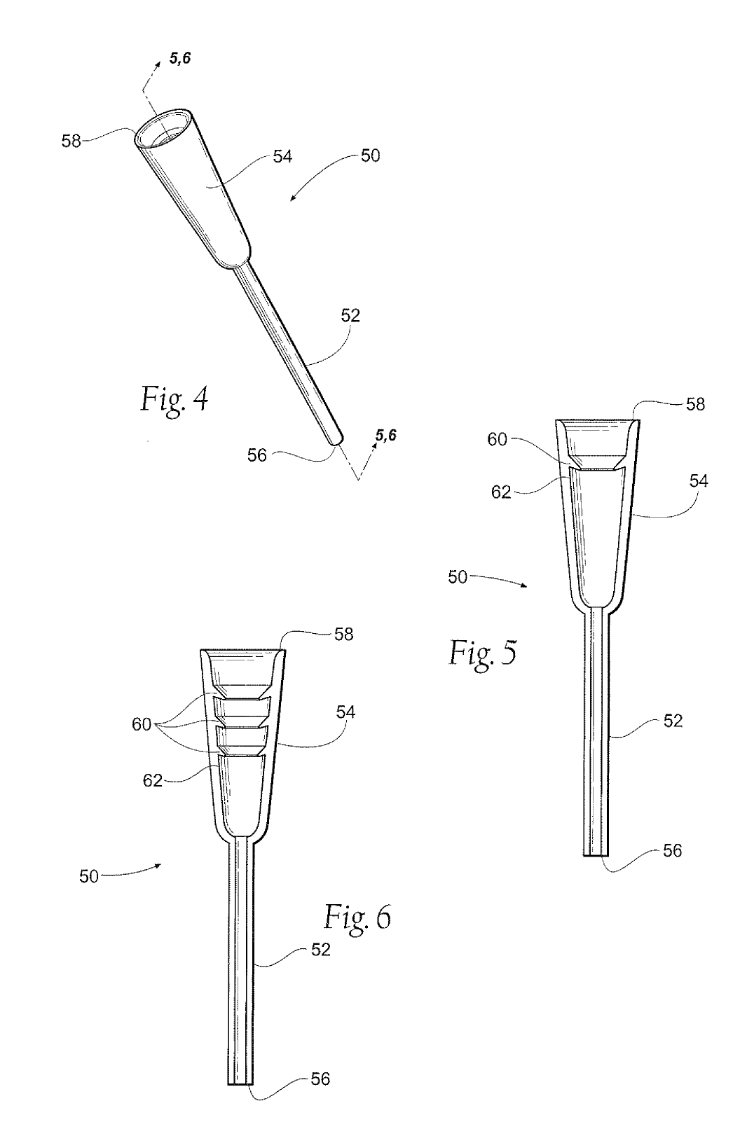

As discussed, above, the amount of material 26 delivered out of the nozzle end 28 is more than desirable for many dental procedures, particularly dental procedures employing microscope enhanced procedures (MEP), but for general dental procedures, as well. The amount of material 26 needed at a specific time for procedure is generally less than a specific amount of material exiting the nozzle end 28, and it is desirous to deliver only a precise amount of material. FIG. 4 provides an improved applicator tip 50 according to the present invention that will assist the user in delivering a smaller, metered amount of dental material 26.

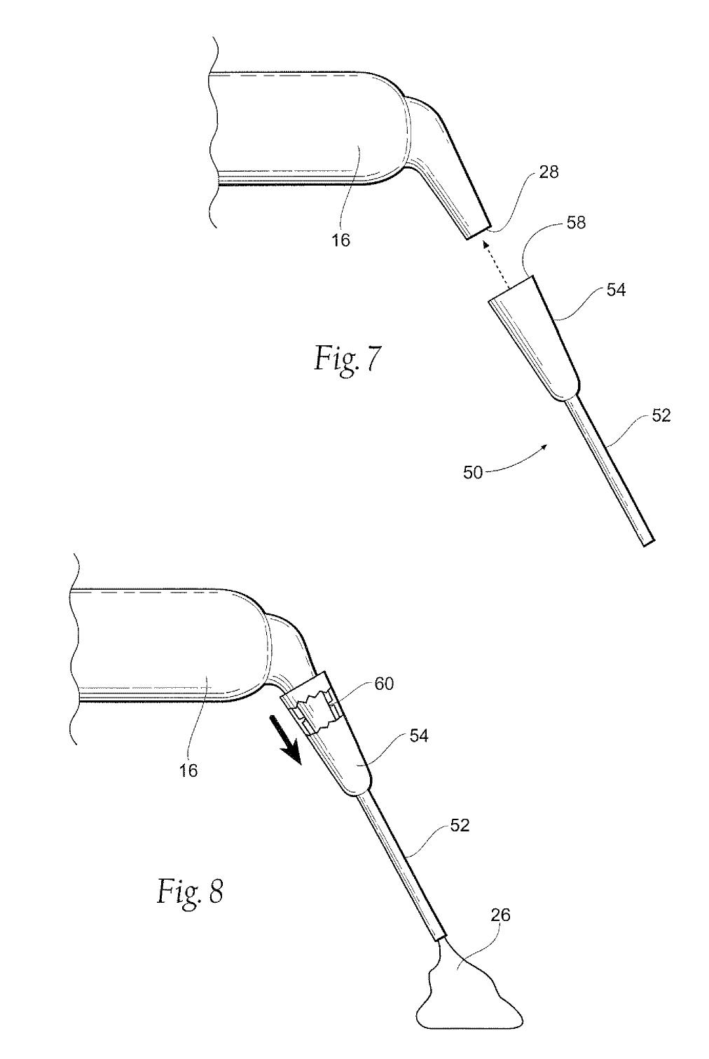

The applicator tip 50 generally comprises a first portion 52 and a second portion 54. The first portion 52 generally comprises a narrow cylindrical shape and further comprises a fluid exit 56 for eventual delivery of the dental material 26. The second portion 54 comprises a generally conical shape, with an opening 58 that is arranged to receive the nozzle end 28, as is shown in FIG. 7. Preferably the second portion 54 is of such a shape that it will be matingly fitted over the outer diameter of the nozzle end 28.

FIGS. 5 and 6 provide cross-sectional views of the tip 50. FIG. 5 shows a barb 60 located on the inner surface 62 of the second portion 54. Preferably, the barb 60 circumferentially surrounds the inner surface 62 of the second portion 54. FIG. 6 shows a similar arrangement to that of FIG. 5, with the distinction being that multiple barbs 60 are spaced apart on the inner surface 62, as opposed to the single barb of FIG. 5. As described in FIG. 5, the barbs in FIG. 6 preferably circumferentially surround the inner surface 62. While not necessary, such an arrangement can further contribute to a fluid tight connection between the nozzle end 28 and the applicator tip 50.

As shown in FIG. 7, the applicator tip 50 is applied over the outer diameter of the nozzle end 28, preferably with the nozzle end 28 being inserted into the applicator tip 50 so that the second portion 54 matingly surrounds the nozzle end 28. The applicator tip 50 can be designed so that the nozzle end 28 will be flush where the second portion 54 meets the first portion 52 when the tip 50 and the nozzle 28 are mated. However, the nozzle end 28 can be inserted any distance that will sufficiently mate with the applicator tip 50, as it is understood that the applicator tip 50 can be of a various number of arrangements and designs.

Once the applicator tip 50 is matingly positioned on the nozzle end 28, the device 10 can be used to deliver the dental material 26, as shown in FIG. 8. Though the viscosity of the dental material causes a downward pressure during the delivery process, as depicted by the arrow in FIG. 8, the applicator tip 50 will retain contact with the nozzle end 28. As the cutaway view of the applicator 50 shows, the barbs 60 will grab or bite into the material of the nozzle end 28, thereby preventing the applicator tip 50 from coming separated from the nozzle end 28. Thus, the applicator tip 50 allows for small, precisely metered amount of dental material 26 to be delivered for a dental procedure.

The applicator tip 50 is merely exemplary of possible devices that can be used according to the present invention to deliver small, metered amounts of restorative dental material. For example, the use of threads, rings, or other devices could be incorporated into the applicator tip 50 instead of the use of barbs 60, or could be used in concert with the barbs 60, to secure the applicator tip 50 to the nozzle end 28. For example, FIG. 10 demonstrates the tip 50 employing a threaded surface 160 instead of barbs 60. Provided that an applicator tip is capable of being mated externally with the dental material container or source in a secure fashion during the delivery of the dental material, the device would fall within the scope of the present invention.

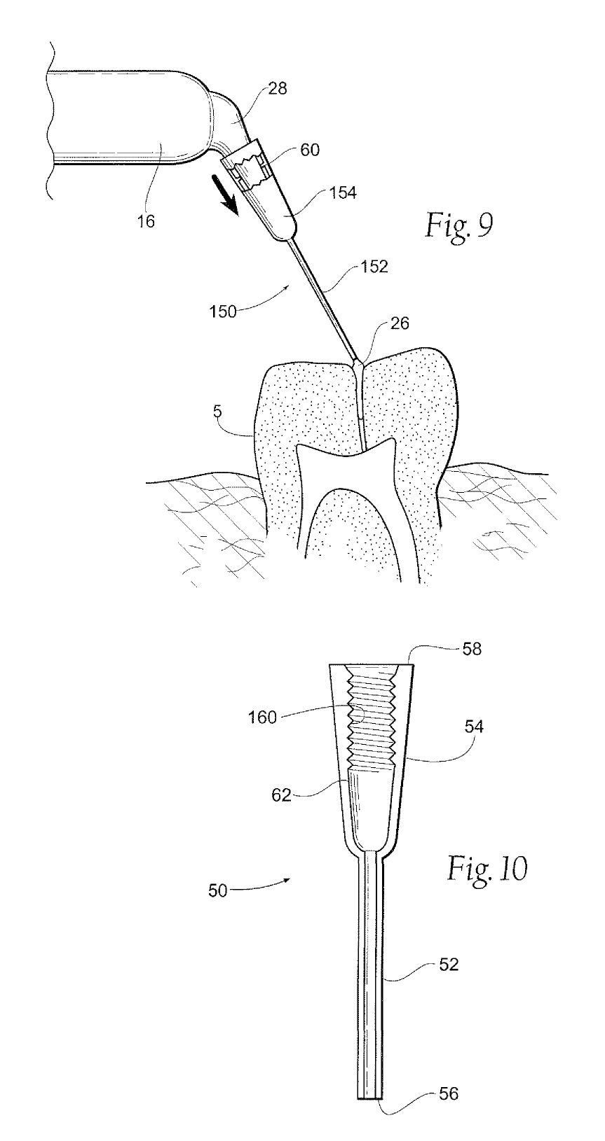

Likewise, the diameter, length and other dimensions could be altered and still fall within the scope of the present invention. For example, FIG. 9 shows a tip 150. The tip 150 attaches to the nozzle end 28 similarly as the tip 50, with a second portion 154 having attachment means 60, but has a lengthened first portion 152 as compared to the first portion 52 of the tip 50. The tips of the present invention are for applying flowable composite, a non-viscous dental adhesive, directly into pits and fissures in a tooth or teeth 5. Use of the tip 150 provides a procedural improvement over prior art methods and tips which require a combined needle-compule device with a large opening to dispense the material, which was then pushed into the spaces with separate toothpicks or other pointed objects. The present invention eliminates and/or minimizes the necessity of needing to use these toothpicks or other sharp objects.

The design of the tip 150 can be used to apply highly-filled and glass ionomer composites, i.e. extremely viscous dental adhesives, directly into pits and fissures created primarily by a dentist's removal of carious enamel and dentin. The tips 150 provide a procedural improvement over current methods which use only the compule devices, which have openings typically corresponding to 10-14 gauge needles.

As previously described with respect to tips 50, the tips 150 can be easily attached to essentially any manufacturer's compule tip, regardless of small variations in tip diameter and taper, to extend the reach of the compule tip and to provide a small orifice through which these adhesives can be delivered. This is particularly useful for microscope-enhanced dental procedures, in which cases a dentist's preparation may be smaller in diameter than the orifice of a standard compule. The tip 150 will fit in more of these small preparations which allows for improved filling with reduced trapping of air bubbles, and they allow dentists to more effectively engage in minimally invasive preparation and filling of infected or perforated teeth.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A applicator tip for dental materials from a delivery device having a nozzle, said applicator tip comprising:
means for attaching said applicator tip to said external surface of said nozzle.

2. The applicator tip of claim 1, further comprising:
a first portion for delivering dental materials, and
a second portion comprising said attaching means,
wherein said first portion has a smaller diameter than said second portion.

3. The applicator tip of claim 1, wherein said attaching means comprises a barb located on the inner surface of said applicator tip.

4. The applicator tip of claim 3, wherein said attaching means comprises a plurality of barbs located on the inner surface of said applicator tip.

5. The applicator tip of claim 1, wherein said attaching means comprises a screw thread.

6. An applicator tip for delivering a metered amount of viscous dental material from a delivery device, said applicator tip comprising:
an inner surface portion for gripping a portion of the outer surface of the delivery device.

7. The applicator tip according to claim 6, further comprising an elongated cylindrical portion or conical portion having a fluid exit.

8. The applicator tip according to claim 7, further comprising a second portion, said second portion comprising said inner surface portion, wherein said diameter of said inner surface portion is less than said diameter of said elongated cylindrical or conical portion.

9. An applicator tip for delivering a viscous dental material from a delivery device having a delivery nozzle, the applicator tip comprising:
a first portion comprising an elongated cylindrical having a fluid exit;
a second portion connected to said first portion, said second portion generally being in a mating shape with said delivery nozzle; and
means for grippingly mating said applicator tip with said external surface of said delivery nozzle, said means located on said internal surface of said second portion of said applicator tip.

10. The applicator tip according to claim 9 wherein said first portion is capable of positioning said viscous dental material within a dental pit or fissure.

11. The applicator tip according to claim 9 wherein said attachment means is selected from the group consisting of: threads, barbs, self-tapping threads, rings, a friction fit apparatus, or combinations thereof.
